(19) United States
(12) Patent Application Publication
(10) Pub. No.: US 2018/0340367 A1
(43) Pub. Date: Nov. 29, 2018

(54) Garage Door (Drop Down) Breeze Screen

(71) Applicant: Richard Eugene Logsdon, SR., Bellevue, NE (US)

(72) Inventor: Richard Eugene Logsdon, SR., Bellevue, NE (US)

(21) Appl. No.: 15/927,911

(22) Filed: Jun. 7, 2018

Related U.S. Application Data
(60) Provisional application No. 62/489,769, filed on Apr. 25, 2017.

(51) Int. Cl. E06B 7/10; E06B 9/52

(52) U.S. Cl. CPC E06B 7/10; E06B 5/003; E06B 9/52

(57) ABSTRACT

The “Breeze screen” invention concept is designed to serve as a simulated natural “breeze gate” to keep garages cool and clean when they are opened. The mesh “breeze gate” feature serves to keep garbage and debris out of the inside garage space, while allowing the natural outdoor air ventilation in to keep the garage cool. It attaches to the existing garage door and can be “dropped down” and locked in place for security with its use.

It functions by the design of a fine mesh panel or “screen” network, made of either metal, aluminum, plastic or other fabric of manufacturer's choice to allow airflow through the fine “air holes” that make up the “breeze gate” or “breeze screen” concept. Thus allowing air through to keep the garage cooler, but keeping larger unsightly particles out of the garage, such as leaves, trash and debris.

### FIELD OF THE INVENTION

The present invention relates generally to a drop-down screen specifically for a garage door.

### BACKGROUND OF THE INVENTION

The invention is designed to serve as a simulated natural “breeze gate” to keep garages cool. It functions by the design of a fine mesh screen network, made of either metal, aluminum, plastic or other fabric of manufacturer's choice to allow airflow through the fine “air holes” that make up the “breeze gate” or “breeze screen” concept.

### CLAIMS

The “Breeze screen” invention concept is designed to serve as a simulated natural “breeze gate” to keep garages cool, while essentially clean, when they are opened. The mesh “breeze gate” feature serves to keep garbage and debris out of the inside garage space, while allowing the natural outdoor air ventilation in to keep the garage cool. It attaches to the existing garage door and can be “dropped down” and locked in place for security with its use.

It functions by the design of a fine mesh panel or “screen” network, made of either metal, aluminum, plastic or other fabric of manufacturer's choice to allow airflow through the fine “air holes” that make up the “breeze gate” or “breeze screen” concept. Thus allowing air through to keep the garage cooler, but keeping larger unsightly particles out of the garage, such as leaves, trash and debris.

### BRIEF DESCRIPTION OF THE DRAWINGS

FIG. 1 is a perspective view of the apparatus where the R panel and L panel mesh screen would be observed as unlocked and the garage door (not depicted) is further off the ground than the screen will extend.

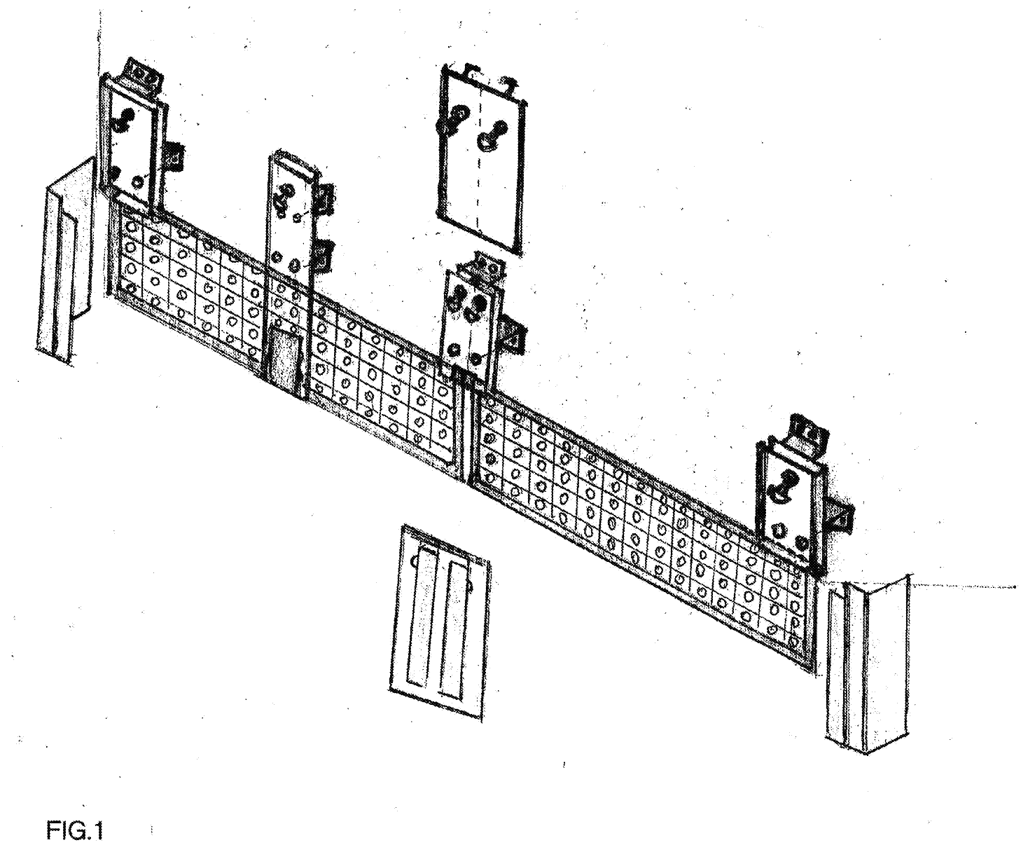

FIG. 2 is a front sectional view of the apparatus thereof.

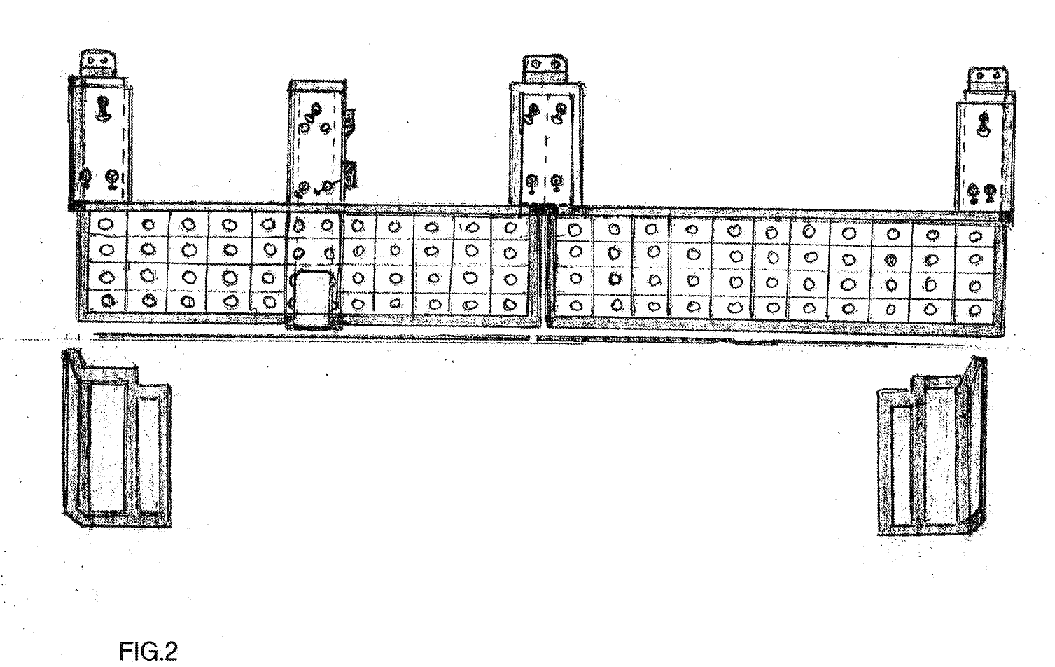

FIG. 3 is a rear sectional view of the apparatus thereof.

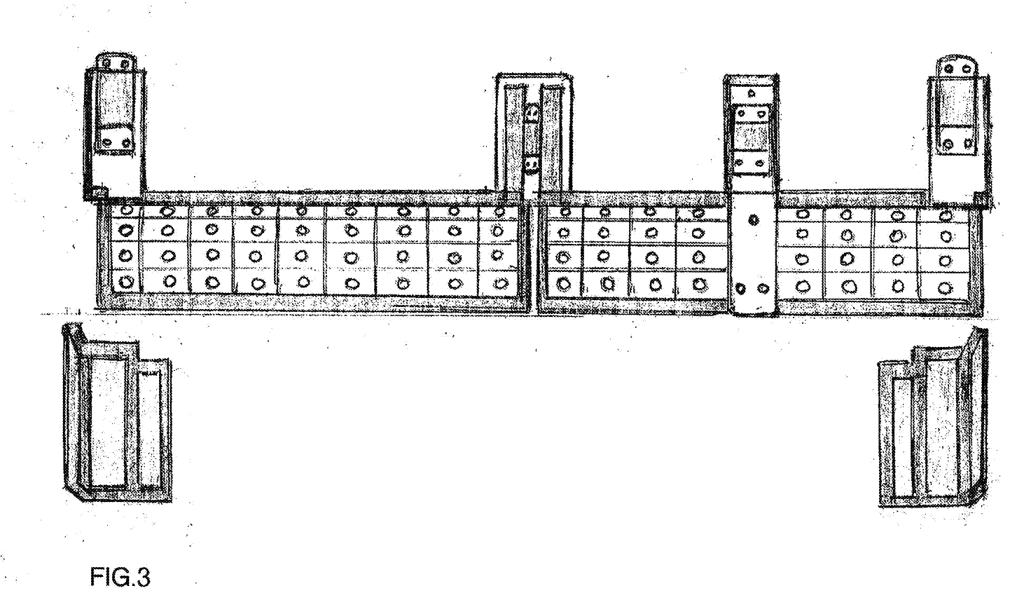

FIG. 4 is a right sectional view of the apparatus thereof.

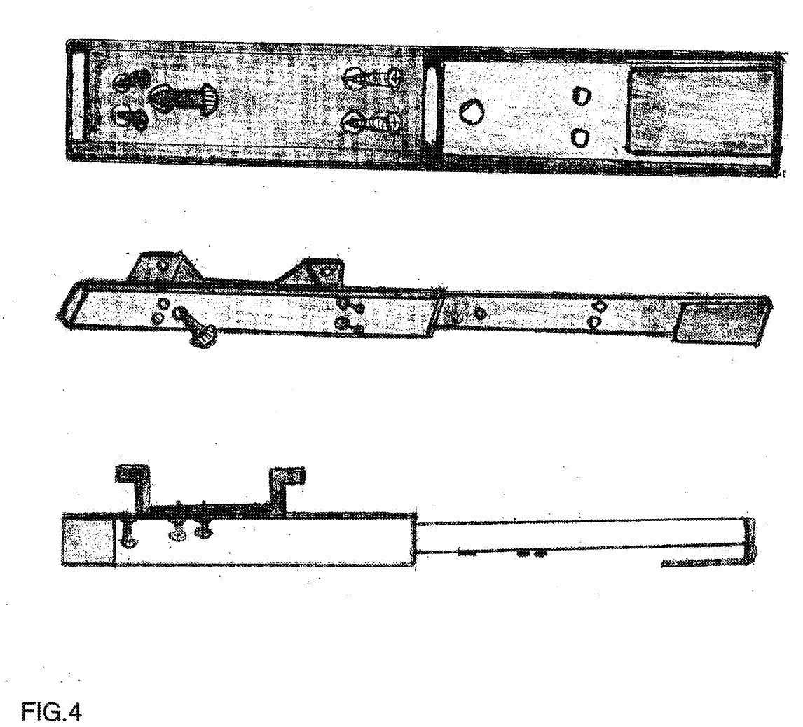

FIG. 5 is a top sectional view of the apparatus thereof.

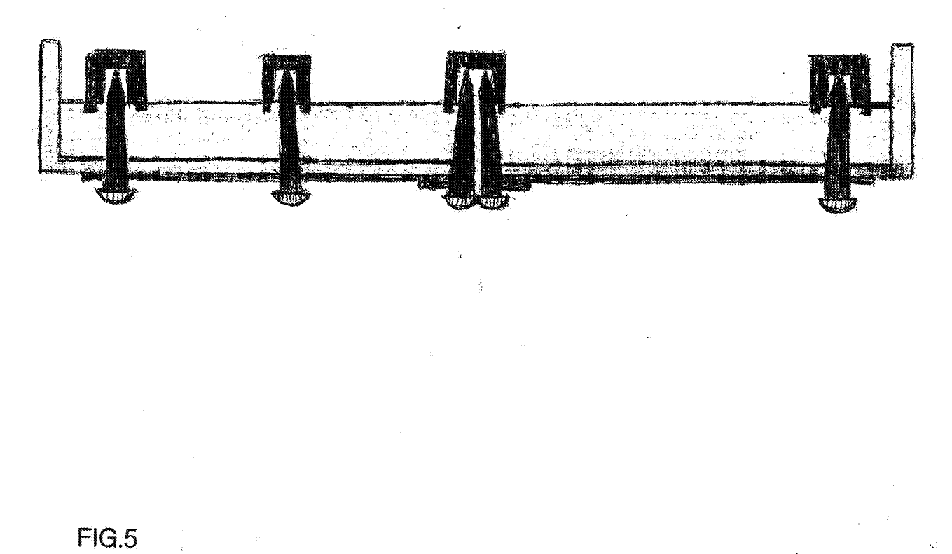

FIG. 6 is a bottom sectional view of the apparatus thereof.

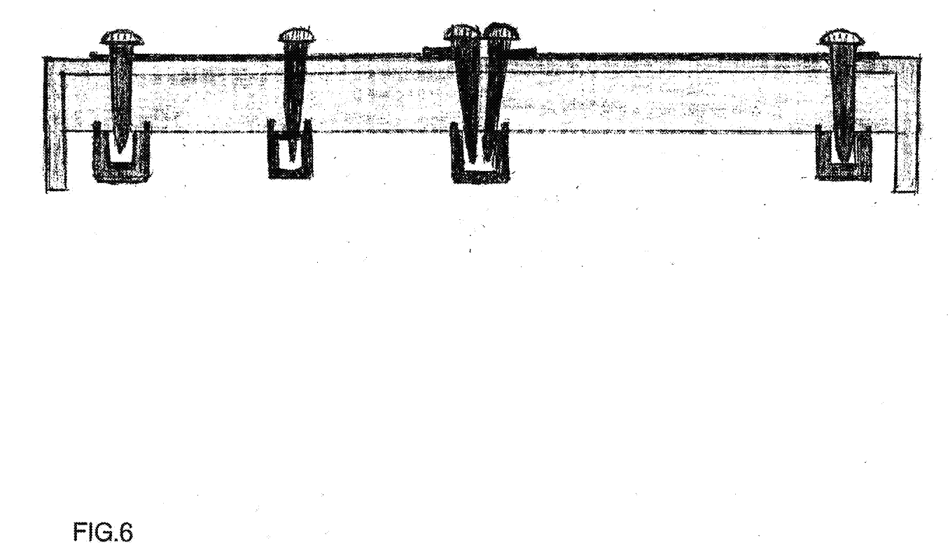

FIG. 7 is a perspective view of the apparatus where the screen is observed to be locked and garage door (not depicted) is further off the ground than the screen will extend.

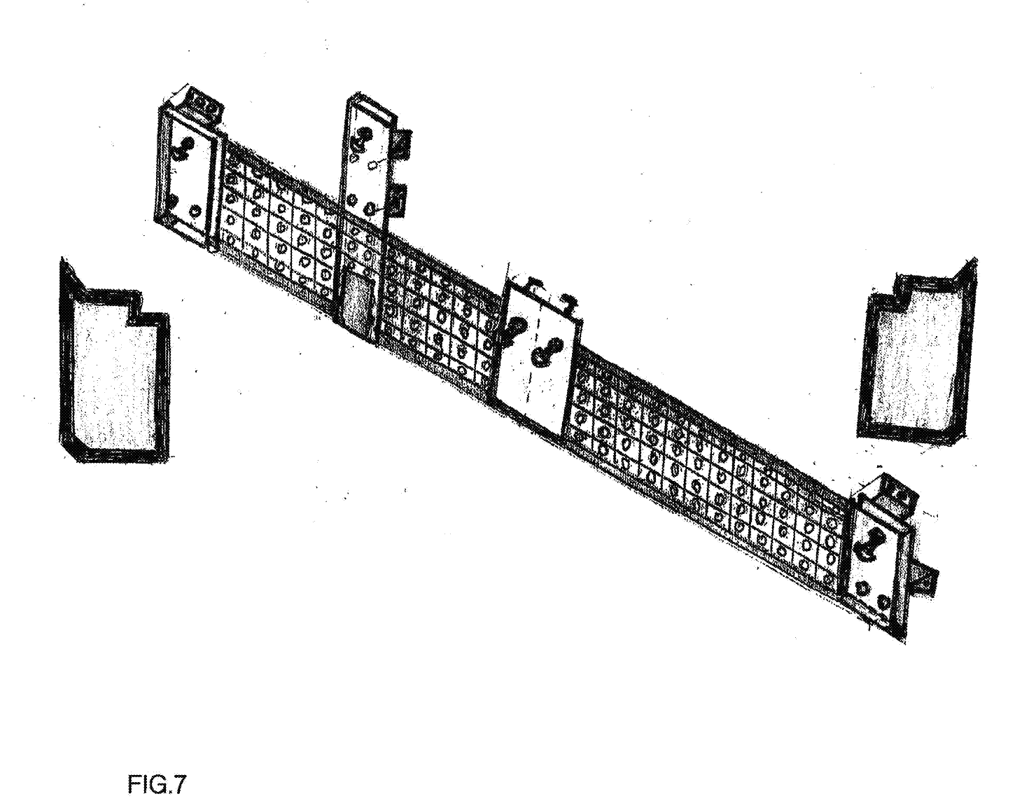

FIG. 8 is a trimetric view of the apparatus where the screen is observed to be locked and the garage door (not depicted) is fully lowered and would be considered flush with the ground.

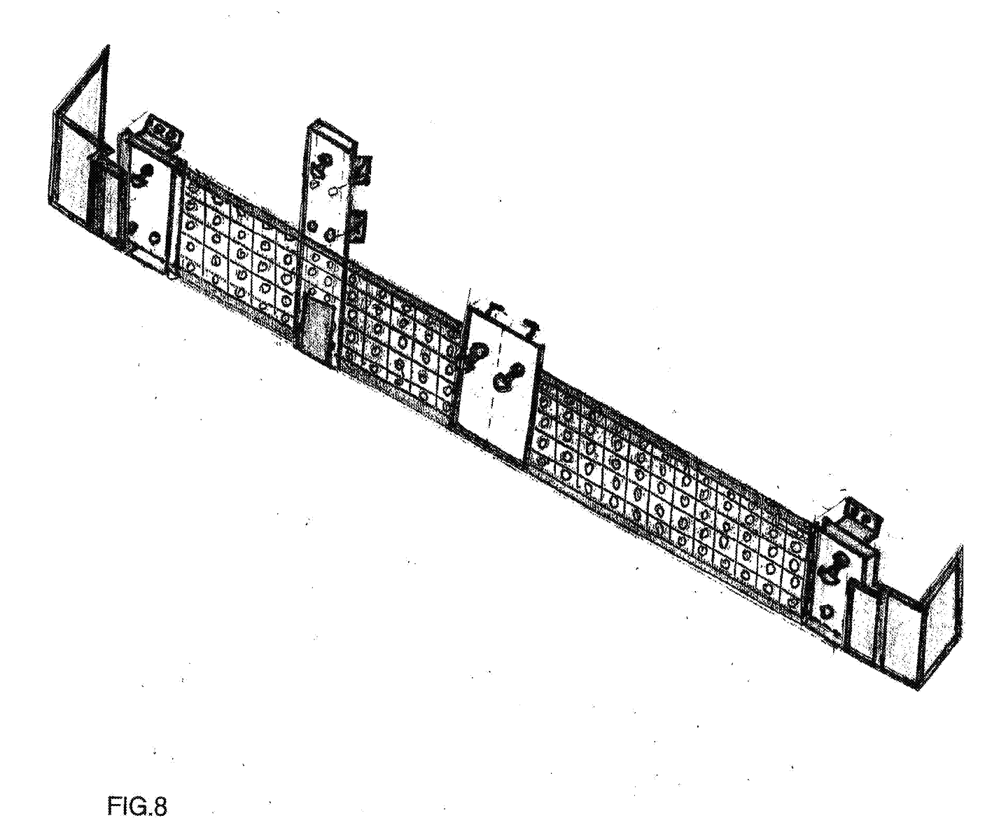

FIG. 9 is a perspective view of the apparatus where the screen is observed to be unlocked and the garage door (not depicted) is lifted off the ground to the extent the screen will extend.

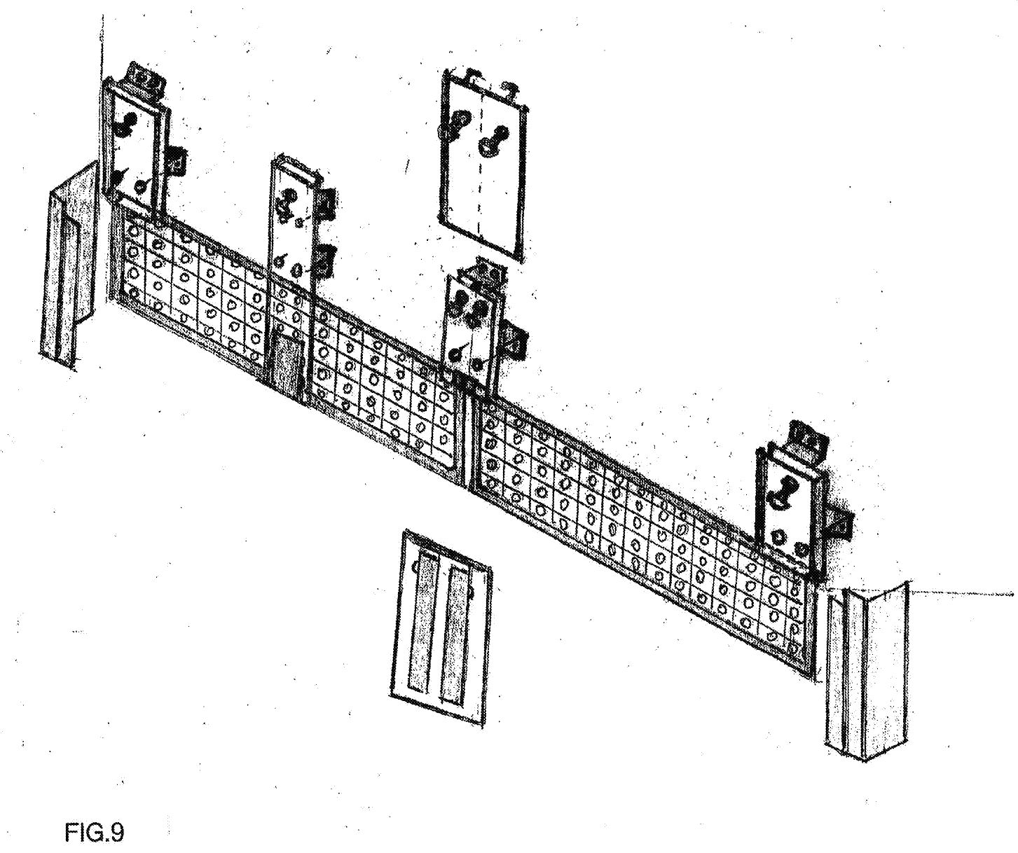

FIG. 10 is a perspective exploded view of the end assemblies consisting of the end bracket closure (front subassembly), end bracket with pin-lock (midplane subassembly), and back brace (rear).

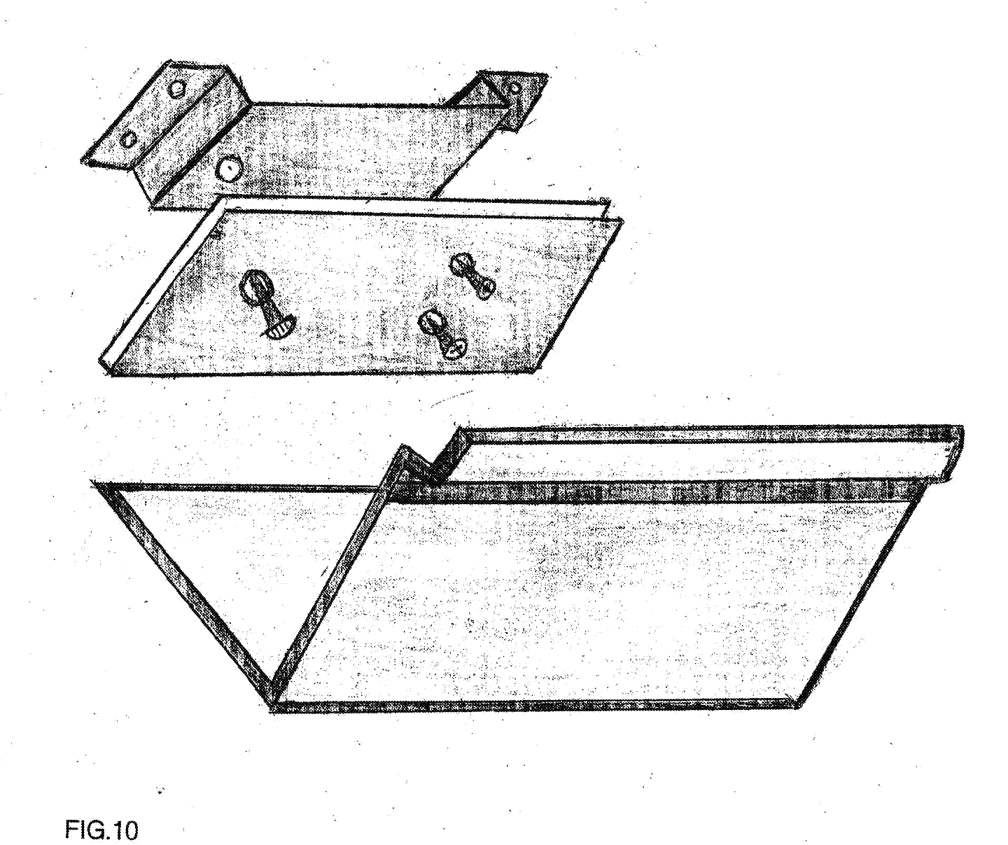

FIG. 11 is a perspective view of the end assembly thereof when the pinlock is engaged with the end bracket.

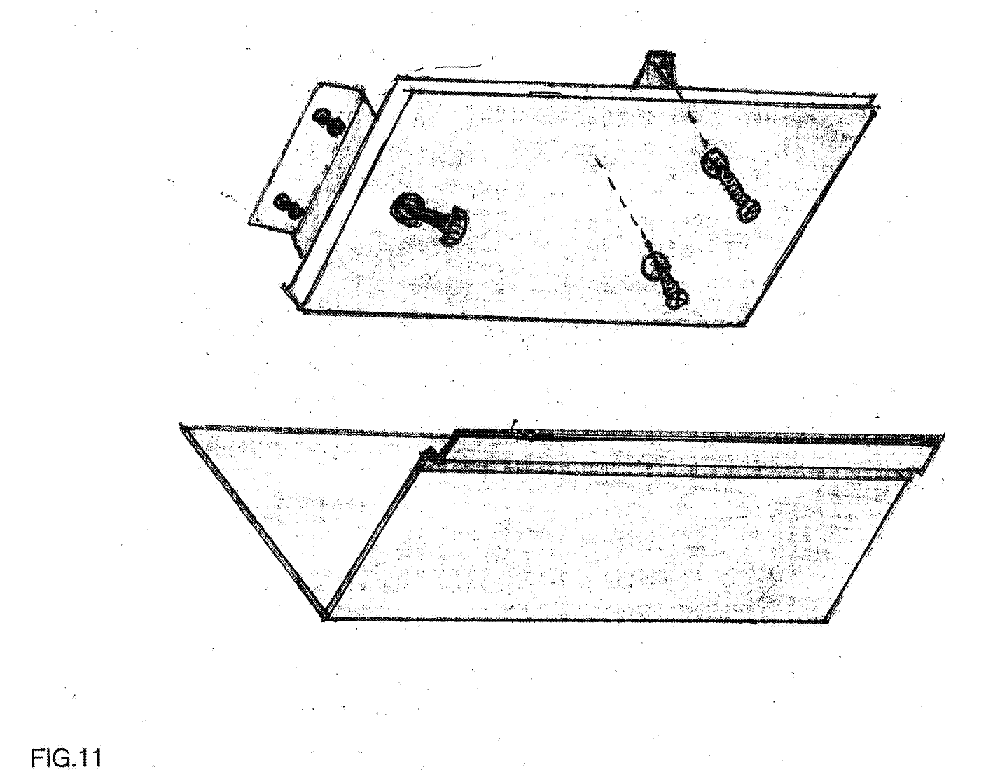

FIG. 12 is a right sectional view of the end assembly thereof where the front face of the end bracket is to lie flush or near flush with the rear face of the end bracket closure flange member.

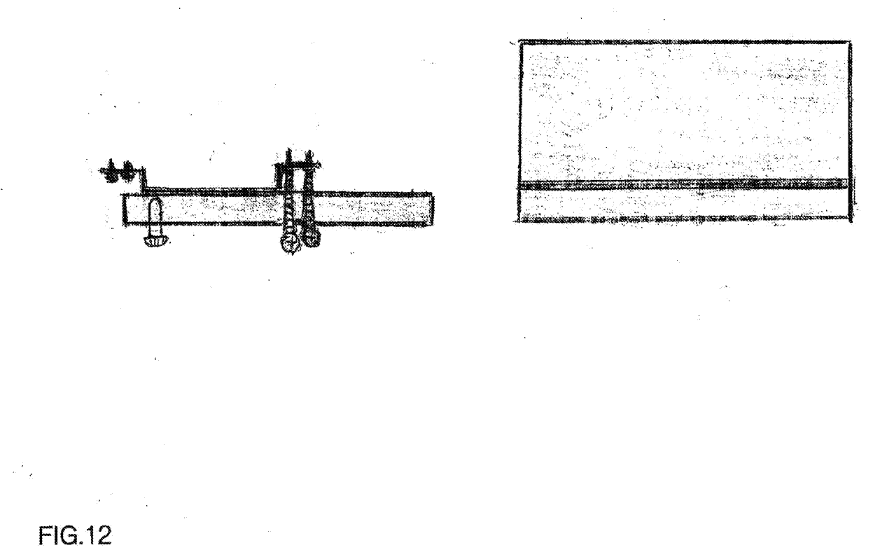

FIG. 13 is a bottom sectional view of the end assembly thereof where the flange member possesses a square tab stop to restrict the motion of the end bracket.

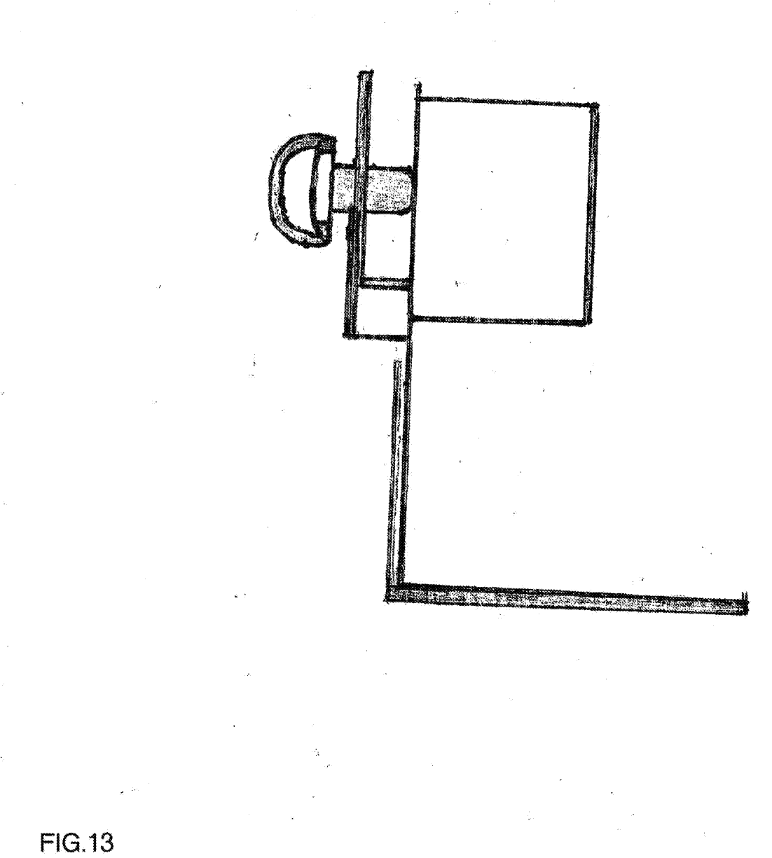

FIG. 14 is a perspective exploded view of the center bracket subassembly consisting of the center bracket open space closure and pinlock (front subassembly), center bracket and center insert (midplane left and midplane right respectively), and back brace (rear).

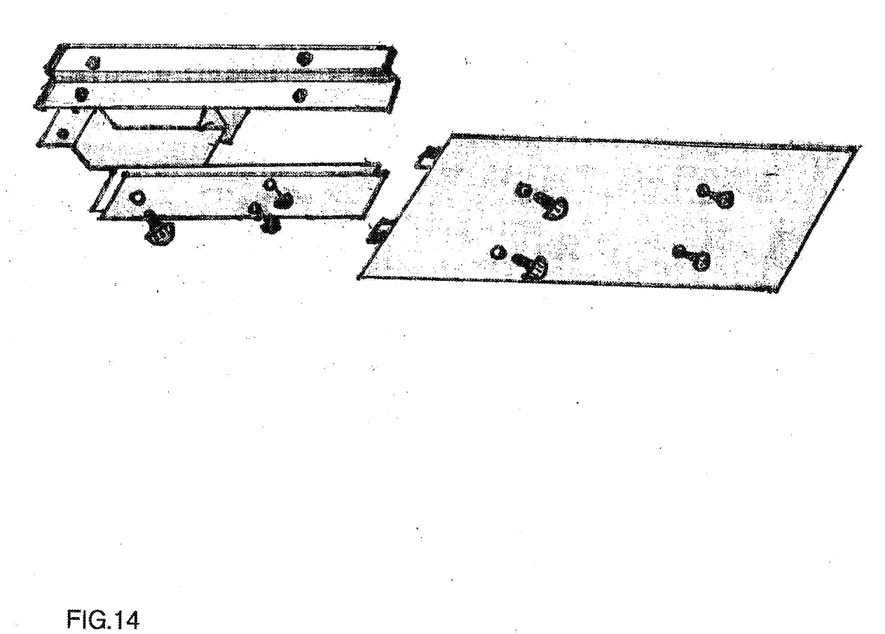

FIG. 15 is a right sectional exploded view of the center assembly thereof where the center insert would be located within the center bracket when assembled.

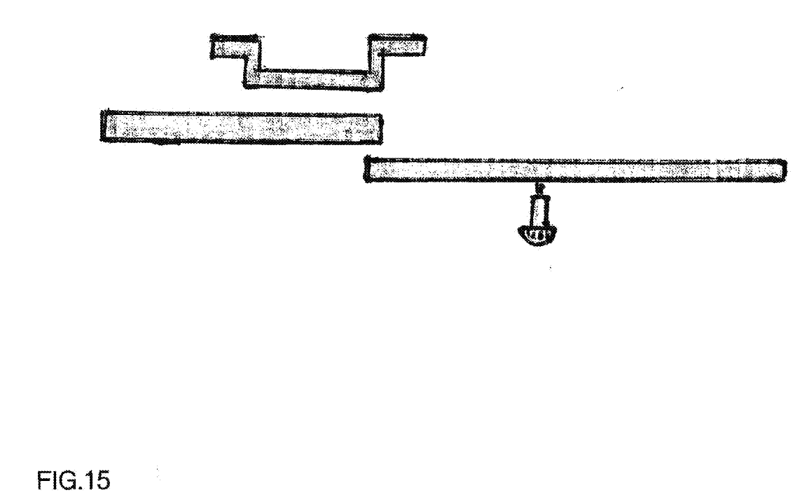

FIG. 16 is a perspective view of the center bracket subassembly where the pin locks are unlocked.

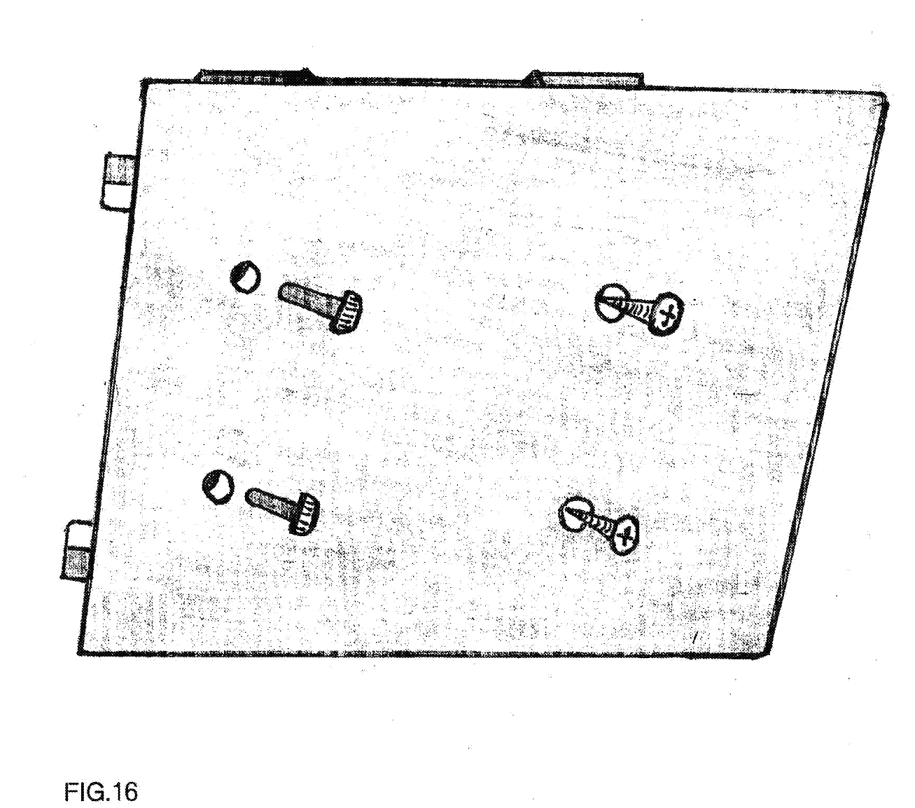

FIG. 17 is a top sectional view of the center assembly thereof where the center bracket and center insert are slotted into the flange member on the rear of the center bracket open space closure.

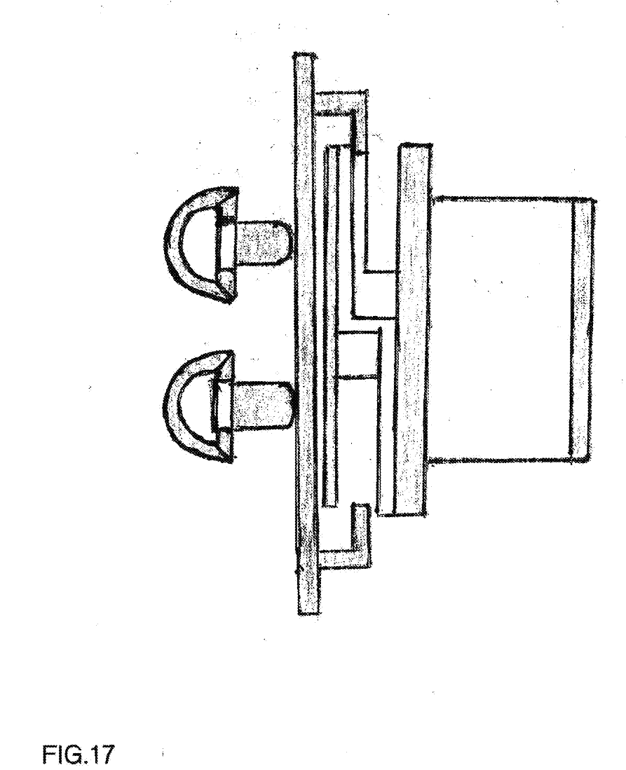

FIG. 18 is a perspective exploded view of the slide bracket subassembly consisting of the slide body-slide body bracket and pinlock (midplane top subassembly), slider (midplane bottom), and back brace (rear).

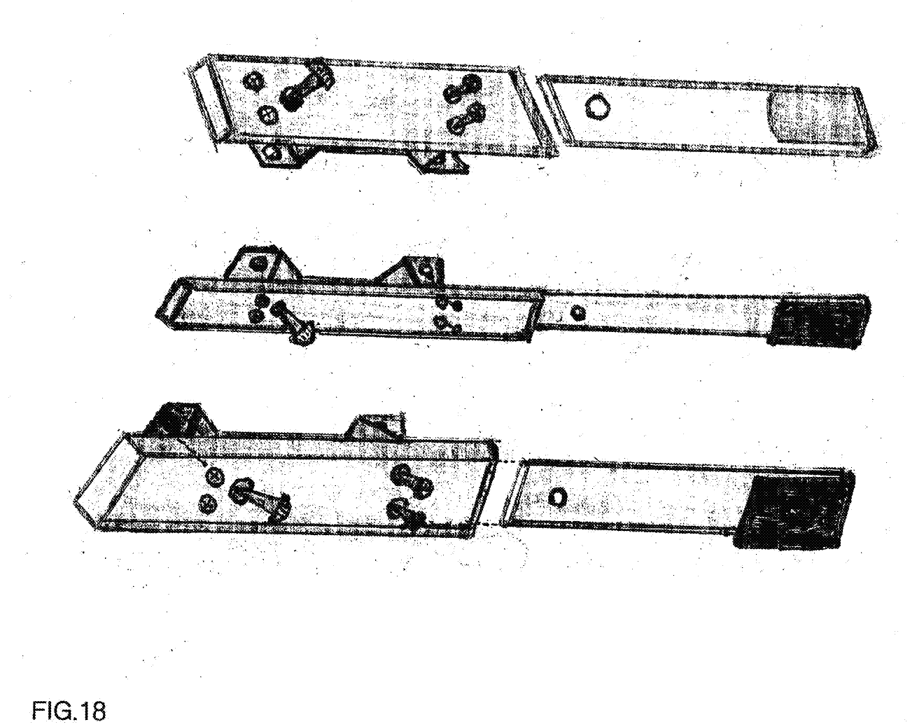

FIG. 19 is a perspective view of the slider bracket where the slider is unlocked and extending out the bottom of the slider body flange and secured to the slide bracket body and back brace.

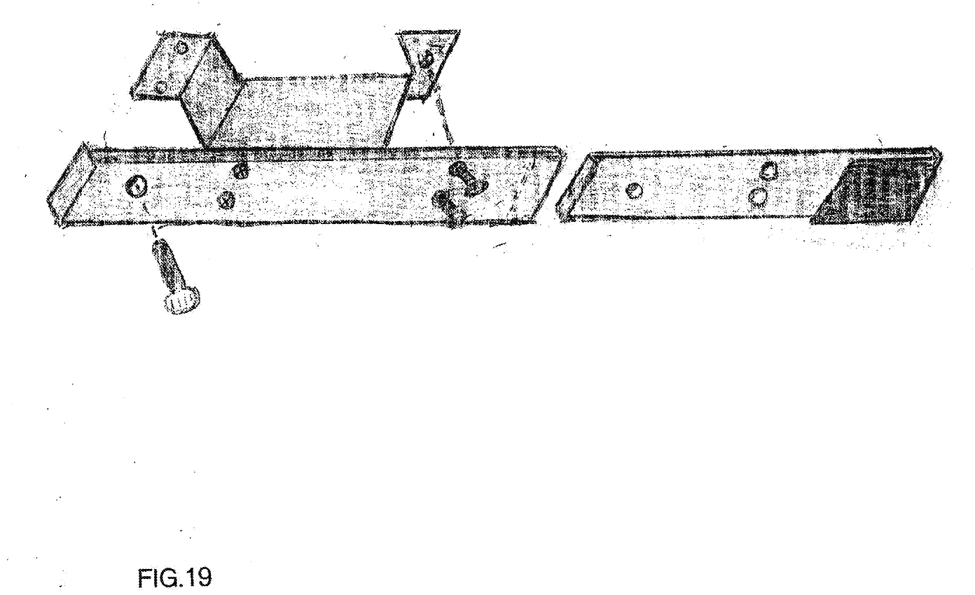

FIG. 20 is a full front view of the drop-down “Breeze screen” mesh panels. Materials used can vary according to a manufacturer's preference.

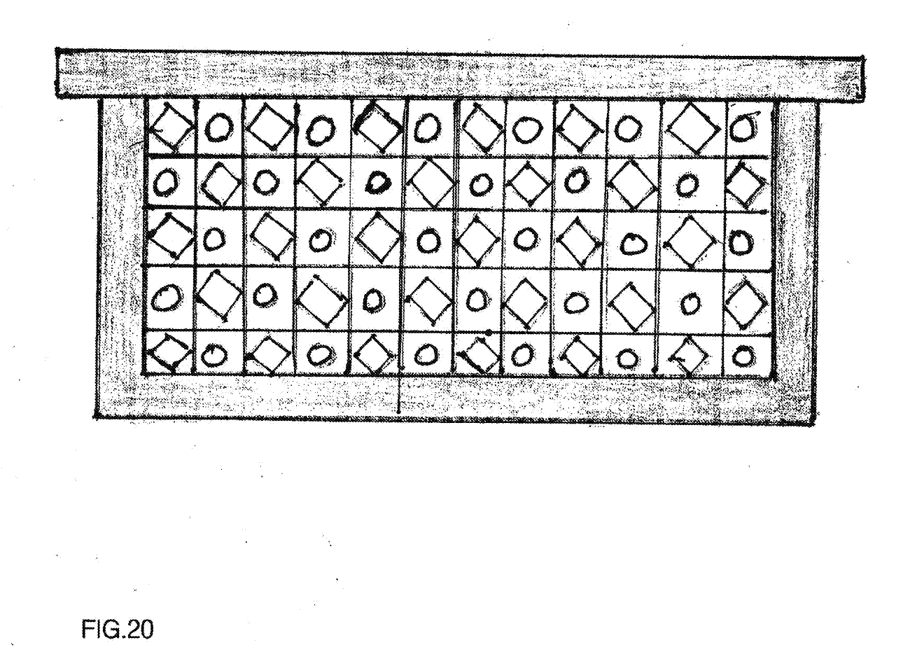

### DETAIL DESCRIPTIONS OF THE INVENTION

All illustrations of the drawings are for the purpose of describing selected versions of the present invention and are not intended to limit the scope of the present invention.

The invention relates generally to a drop-down screen door that is comprised of a center bracket, a plurality of end brackets, a plurality of back braces, an optional center bracket closure, a plurality of optional end cover closures, optional slider bracket, and a plurality of breeze screens. The center bracket is further comprised of a center insert. The apparatus further possesses a plurality of undepicted fasteners that secure the plurality of back braces to the other sub systems.

A “center bracket” (see drawings) is installed and mounted directly onto the inside garage door, in the center of it. This is at floor level. (Not required for garage doors under 16 ft). Two “end brackets” are installed directly onto the inside garage door itself at each end. These are at floor level. The two “end brackets” in combination with the “center bracket” hold the Breeze Screen, allowing it to “slide” into place, just as a track would guide an object into place. The concept allows the two “end brackets”, as previously described, to hold and allow a single mesh panel of manufacturer's material of preference or choice (“Breeze Gate or Screen”) to slide down and let airflow in, without debris, when the garage door is up (open). On garage doors that are 16 ft or wider, there will be two 8 foot panels, a R panel and a L panel, with the “Center Bracket” to support them. Note—
*When installing door brackets, use the breeze screen measurements as indicated (see drawings) for accuracy. There are 20 drawings in total for manufacturer's reference.
A. “Center Bracket” suggested dimensions—12″ h×2.5″ w×⅜″ inside diameter (see drawings); not required for garage doors under 16 ft.
B. “End Brackets” (two in count) suggested dimensions—12″ h×2.5″ w×⅜″ inside diameter (see drawings)
C. “Center Insert” holds two piece “center bracket” together; suggested dimensions—12″ h×2.5″ w. (see drawings 1-9, 14-17, 20)
D. “Back Brace” attaches to the back of all brackets before installing them to the garage door (to assist with proper function). (See drawings 1, 4-12, 20).
E. “Breeze Gate or Breeze Screen”, 2 panels RIGHT SCREEN & LEFT SCREEN PANELS—Suggested measurements—95 and ¾″ w×16″ h. (See drawings 1-9, 20). These measurements are for an average 16 ft garage, but can be modified as desired by manufacturers.
F. “Optional Brackets” are available or can be used as an “option” if needed to further decrease any possible space/gaps to prevent debris. See “Center Bracket closure” drawings 14-17; see “End Bracket closure” drawing 10-13. See “Slide Bracket” for use on garage doors over 16 ft or larger if needed. (See drawings 18, 19).
G. Completed drawing of 16 ft garage (average size, can be modified as desired by manufacturer) with two Breeze Screen panels attached (see drawings 1-9, 20). This drawing shows the completed “Breeze Gate or Breeze Screen” invention. READY TO OPERATE!

Although the invention has been explained in relation to its preferred embodiment, it is to be understood that many other possible modifications and variations can be made without departing from the spirit and scope of the invention.

1. Allow natural outdoor air ventilation in to keep the garage cool. It attaches to the existing garage door and can be “dropped down” and locked in place for security with its use.

2. Keep garbage and large debris out of the inside garage space
